(19) United States
(12) Patent Application Publication
(10) Pub. No.: US 2012/0095821 A1
(43) Pub. Date: Apr. 19, 2012

(54) PURCHASING SYSTEM AND METHOD WITH COMPLIMENTARY USE OF COMPUTER-CONTROLLED ANIMATION OR VIDEO

(76) Inventors: Orlando Chorney Fuquen, Princeton, NJ (US); Stephanie Kim Chorney, Princeton, NJ (US)

(21) Appl. No.: 13/274,731

(22) Filed: Oct. 17, 2011

Related U.S. Application Data
(60) Provisional application No. 61/393,427, filed on Oct. 15, 2010.

(51) Int. Cl. G06Q 30/02

(52) U.S. Cl. 705/14.23

(57) ABSTRACT

A system and method for collective purchasing of a product/service is disclosed. The method includes storing a current price, current number of orders, target price and a target number of orders associated with the product/service. When and order is received to purchase the product/service, the current number of orders is incremented. When the current number of orders equals or exceeds the target number of orders, the current price is updated with the target price. When the current number of orders equals or exceeds the target number of orders, the target price is updated with a new reduced target price. The user may be provided with an animation configured to indicate a relationship between the current number of orders and the target number of orders. A timer can optionally be used to establish a time period during which the product/service is available for sale.

### FIELD OF INVENTION

The present disclosure relates to purchasing systems and methods and systems and methods using animation, e.g., standard web-friendly image file formats and/or video.

### BACKGROUND

Existing on-line shopping systems are typically focused on marketing or selling to a single individual and can be considered traditional in the marketplace today. For example, a typical web site provides detailed information for multiple products that are available for purchase. Individual users simply select products for purchase, add them to their cart and complete the checkout process. In a further derivation of the traditional on-line shopping systems, a way to incentivize the prospective buyer(s) to commit to a purchase, a web site can be configured so that a “deal” price for a product/service can be provided to all and subsequent buyers joining a given “deal”, on the condition that the collective of prospective buyers reach a tipping order point. In order to increase the effective selling conversion of the products/services offered, these on-line shopping systems need to be complemented with a visually appealing web site design and images and supplemented with targeted advertising banners, sometimes rotating, either through the site itself or through 3^{rd} party affiliates that hyperlink back to the site itself. However, these system methodologies, lack interactive indicia or visual elements that personalize the individual user-experience and are purposefully animated or displayed in a system-controlled manner and as close to real-time as possible, so as to for example, further promote the product/service offerings an further influence a prospective buyer(s) to commit to the purchase of such product/service in relation to given quantity or price target. Such a methodology would bring a new level of personalization and salesmanship that is not seen in online e-commerce systems.

### SUMMARY OF THE INVENTION

A system and method for collective purchasing of a product/service is disclosed. The method includes storing a current price, current number of orders, target price and a target number of orders associated with the product/service. An order is received to purchase the product/service and the current number of orders is incremented. On a condition that the current number of orders equals or exceeds the target number of orders, the current price is updated with the target price.

On a condition that the current number of orders equals or exceeds the target number of orders, target price may be updated with a new target price. Current price indicia, current number of orders indicia, target price indicia and target number of orders indicia may be provided.

At least one of the current price indicia, current number of orders indicia, target price indicia and a target number indicia may be animated to reflect changes in the current price, current number of orders, target price or target number of orders. The animation may be configured to indicate a relationship between the current number of orders and the target number of orders.

A time period may be established during which the product/service is available for sale. A timer may be used to store the time period. On a condition that the timer reaches a threshold, a final price may be stored based on the current number of orders. On a condition that the timer reaches a threshold, further purchase of the product/service at the final price may be prevented. Initial order processing may be performed when the order is placed based on the current price; and the order may be finalized based on the final price. The initial order processing may include an authorization hold.

### BRIEF DESCRIPTION OF THE FIGURES

FIG. 1a is a block diagram (screen shot) of a sample web page showing a product available for purchase from a collective purchasing system e-commerce solution as an example with various incentive functionality;

FIG. 1b is a block diagram of the web page of FIG. 11 including a header portion, body portion, billboard portion and right navigation portion;

FIG. 1c is a block diagram showing group deal status information, incentive target information and individual buy commitment information;

FIG. 2 is a flow chart of a checkout procedure;

FIG. 3 is a block diagram of an updated web page showing the number of orders at the current price is now one (1);

FIG. 4 is a block diagram of an updated web page showing the number of orders at the current price is now two (2);

FIG. 5 is a block diagram of an updated web page showing the number of orders at the current price is now three (3);

FIGS. 6 and 7 are block diagrams of a web site showing how the current price drops into the pit and the price porter picks up the new, lower price (target price 32);

FIG. 8 is a block diagram of a web site showing the price porter reset to its original position with a new target price;

FIG. 9 is an example system architecture block diagram;

FIG. 10 is a block diagram showing an example catalog structure;

FIG. 11 is a block diagram of an example group incentive setup process;

FIG. 12 is a block diagram of an example group incentive rules setup process;

FIG. 13 is a block diagram showing basic business information tracking including order tracking information;

FIG. 14 is a flowchart showing group and individual incentive processes working together;

FIG. 15a shows an example of processing an individual or user incentive;

FIG. 15b is a block diagram of an example individual incentive rules setup process;

FIG. 16 is an example block diagram of a checkout process;

FIG. 17 is a block diagram showing various system administration functions;

FIG. 18 details further animation event setup process;

FIG. 19 is a block diagram showing an animation event associated with an order update;

FIG. 20 is a block diagram showing an animation event associated with a new target price;

FIG. 21 is a block diagram of an example common site rules setup process; and

FIG. 22 is a block diagram that shows the relationship by association of one or a plurality of multiple events to a given animation function.

### DETAILED DESCRIPTION

Before explaining embodiments of the invention in detail, it is understood that the invention is not limited in its application to the details of construction and the arrangement of the components set forth in this description or illustrated in the drawings.

Unless otherwise defined, all technical and scientific terms used herein have the same meaning as commonly understood by one of ordinary skill in the art to which the invention belongs. The methods and examples provided herein are illustrative only and not intended to be limiting.

This disclosure provides an innovative structure and method for implementing and managing a purchasing system with the complementary use of animation, e.g., standard web-friendly image file formats and/or video, linked to an intelligent algorithm-based system, to influence actions of an individual user, in order to meet a marketing or sales goal. It is understood that this should not be a limiting approach and it could be also used for non-collective purchasing systems, which are more traditional, with the objective, for example, to offer controlled discounts to individuals interested in purchasing of a product/service.

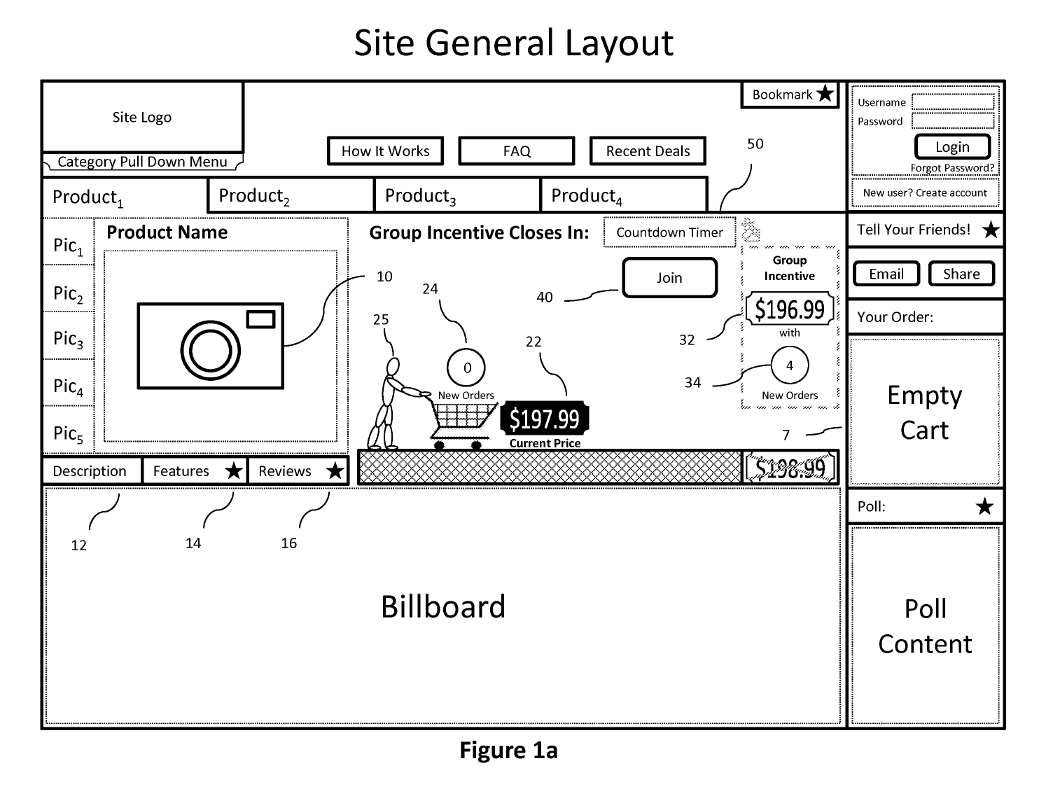

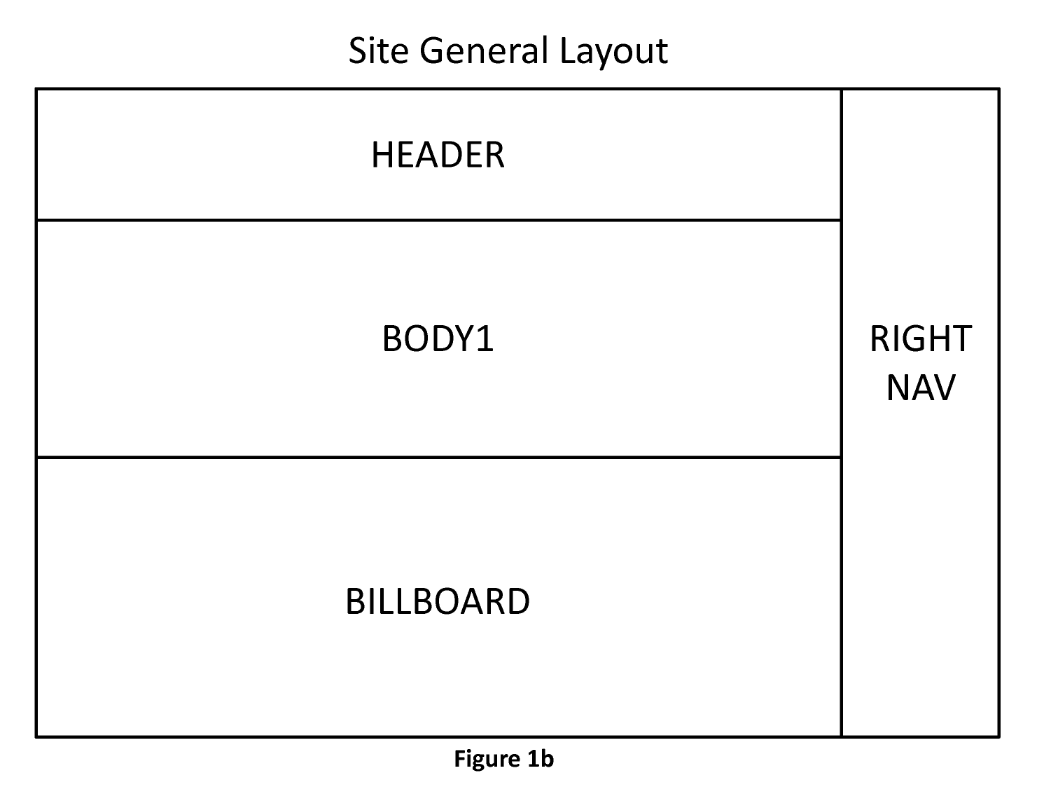

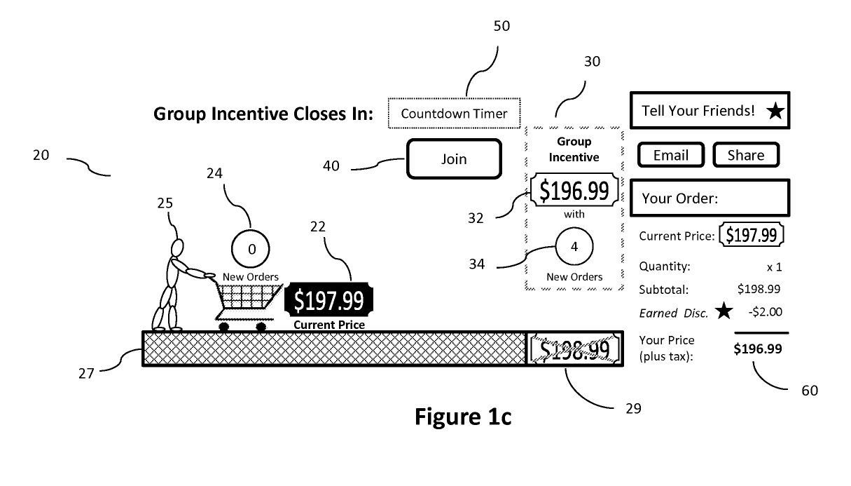

FIG. 1a shows a diagram of a sample web page showing a product available for purchase from a collective purchasing system e-commerce solution as an example with various incentive functionality. The web page can be divided into a plurality of distinct portions or zones as shown in FIG. 1b (e.g., header, body, billboard and right nav). It should be understood that a wide variety of layouts could be used without departing from the scope of this disclosure. The header can generally be used to communication marketing information or slogan information. The billboard portion can be used for promotional or incentive information. The right navigation (nav) portion can be used to convey user specific information, e.g., login status, cart status, mail access, user or individual incentives and other communication options, and can provide access to user specific controls and/or options.

The body portion can generally provide access to information pertaining to one or more group incentives or deals. In this particular example a product/service (camera) is offered for sale for $197.99. As shown in FIG. 1a, the body portion includes information relating to the product/service including one or more product/service images 10, product description 12, product features 14, product reviews 16 and other information 18. The provision of such information is well within the grasp of those skilled in the art. As shown in FIG. 1c, group deal status information 20, incentive target information 30 and individual buy commitment information 60 are also provided. Group deal status information can include the current price 22 and the number of orders at the current price 24. Group incentive information can include a target price 32 and the target number of orders 34. It should be understood that such information can be organized in a variety of ways without departing from the scope of this disclosure. Animation can be used to graphically depict the status of the group deal. To this end, group deal status information can include a price porter 25, a platform 27 and a pit 29.

The system is generally computer implemented and includes a plurality of memory locations associated with a given deal. The system will generally track the numbers of orders and update the web page accordingly. The system also includes a count down timer 50 that is initialized to a starting value at the start of the deal. The count down timer 50 is decremented periodically and upon expiration the deal is completed. While the count down timer 50 is running, users can join the group and order the product/service. Accordingly, the term “order” as used herein can encompass a commitment to purchase a quantity of products/services at the current price. For credit card based transactions, the system can perform an authorization hold for the order based on the current price at the time of the order. The authorization hold will hold a portion of the user's available credit as unavailable to cover the transaction. The final price of the product/service is determined at the expiration of the count down timer 50. The system then can complete the credit card transaction for each user's order based on the final price of the product/service.

Assume for example, the count down timer is running. Each time an order is placed via order button 40, the number of orders 24 is incremented. The animation can be updated to reflect a change in status (e.g., progress towards the target number of orders 34). An updated animation can be presented to each user when they navigate to the site or return to the site to check the status of the deal as discussed in more detail below. Once the target number of orders is reached, the current price 22 is updated with the target price 32 and a new target price (e.g., lower target price) is selected. This process is repeated until the count down timer 50 expires. In this way, users are incentivized to join the deal and push the current price 22 lower. The larger the group, the larger the benefit (e.g., lower price) to the individual group members. Once the group deal closes (e.g., count down time 50 expires) all users are given the current price 22 at that time. When a user navigates to the site (e.g., after the deal closes), they can be presented with an animation showing their current price being replaced with the final price.

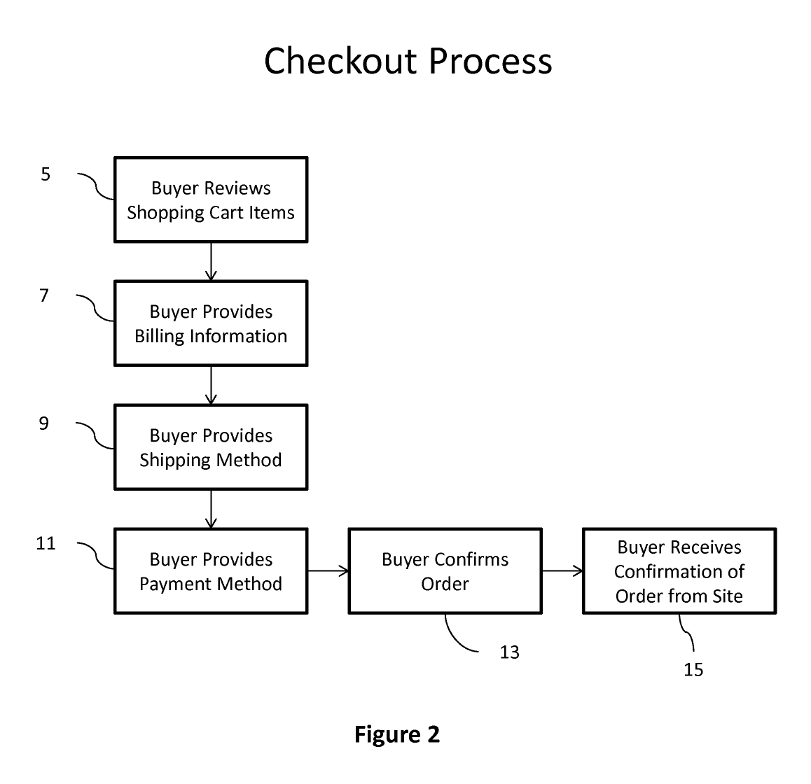

FIG. 1a generally shows a group deal with no progress towards the next target price 32. The price porter is at the far left of the platform 27 and the number of orders at the current price 24 is zero (0). If a user decides to join the group and order the product/service, they select the order button 40 and are then presented with the typical checkout procedure as shown in FIG. 2. The buyer reviews the shopping cart items as shown by block 5. The buyer provides billing information as shown by block 7. The buyer provides shipping information as shown by block 9. The buyer provides a payment method as shown by block 11. The buyer confirms the order as shown by block 13. The buyer then receives confirmation of the order from the web site as shown by block 15. The provision of such information and general administration of an electronic shopping cart is well within the grasp of those skilled in the art. However, as discussed above, the actual price of the product is determined at the close of the deal.

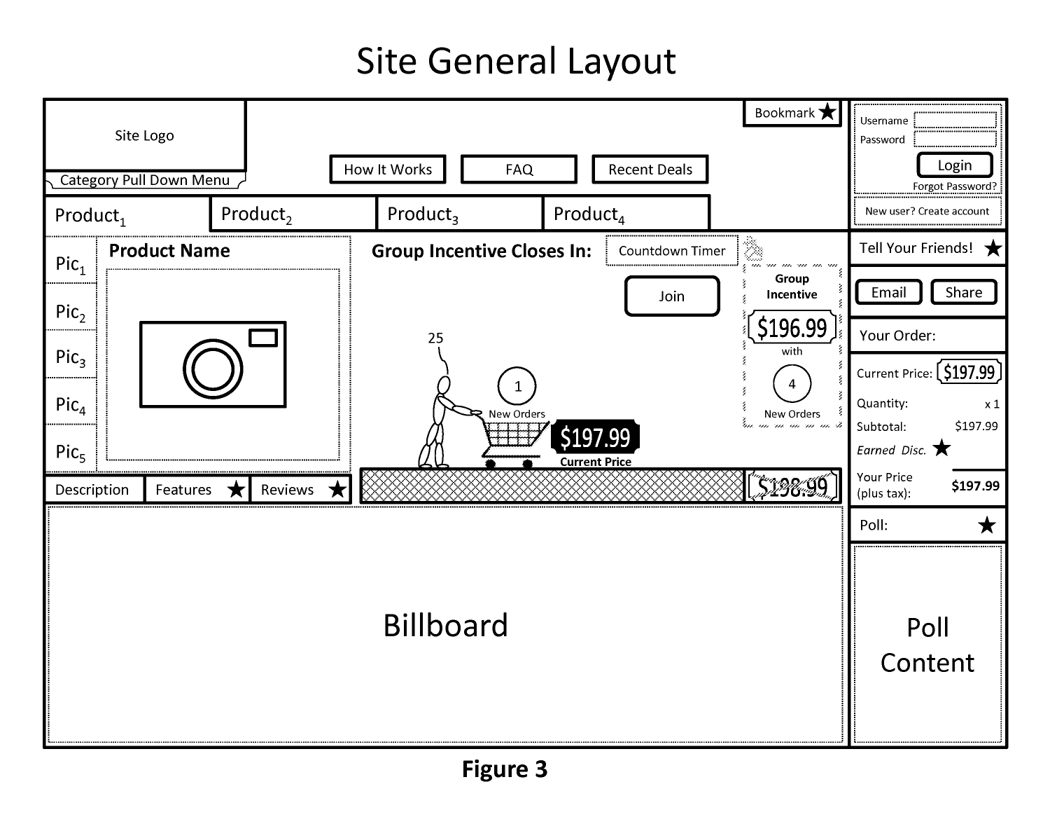

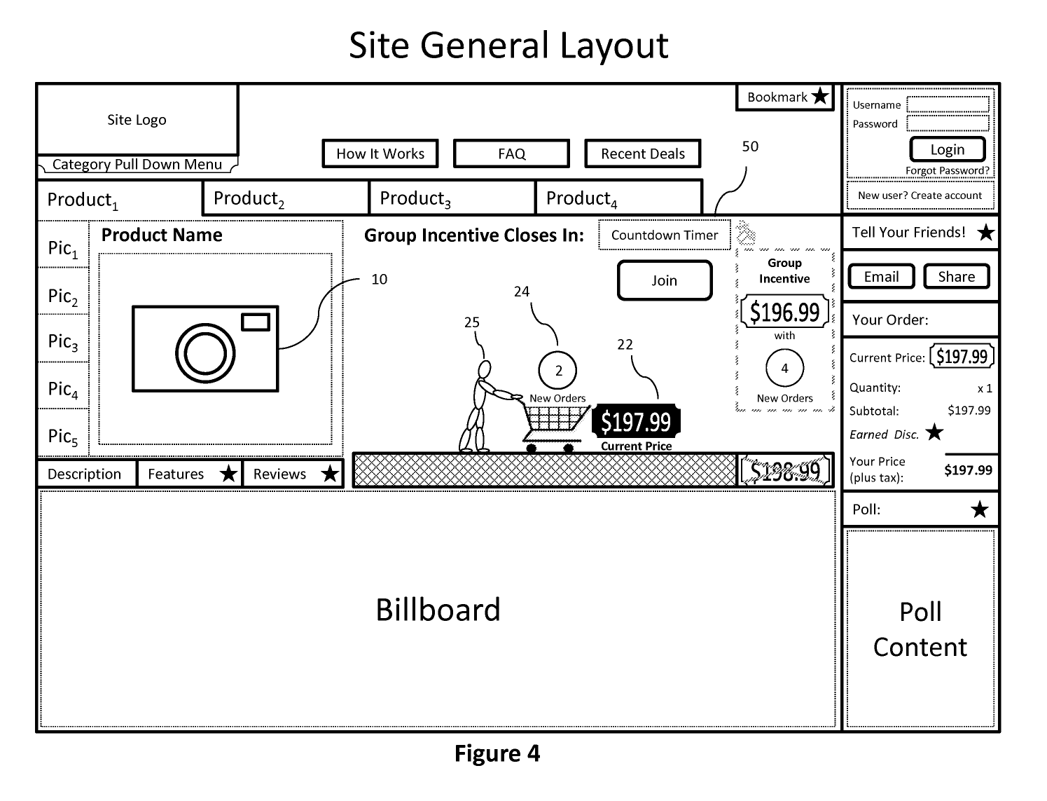

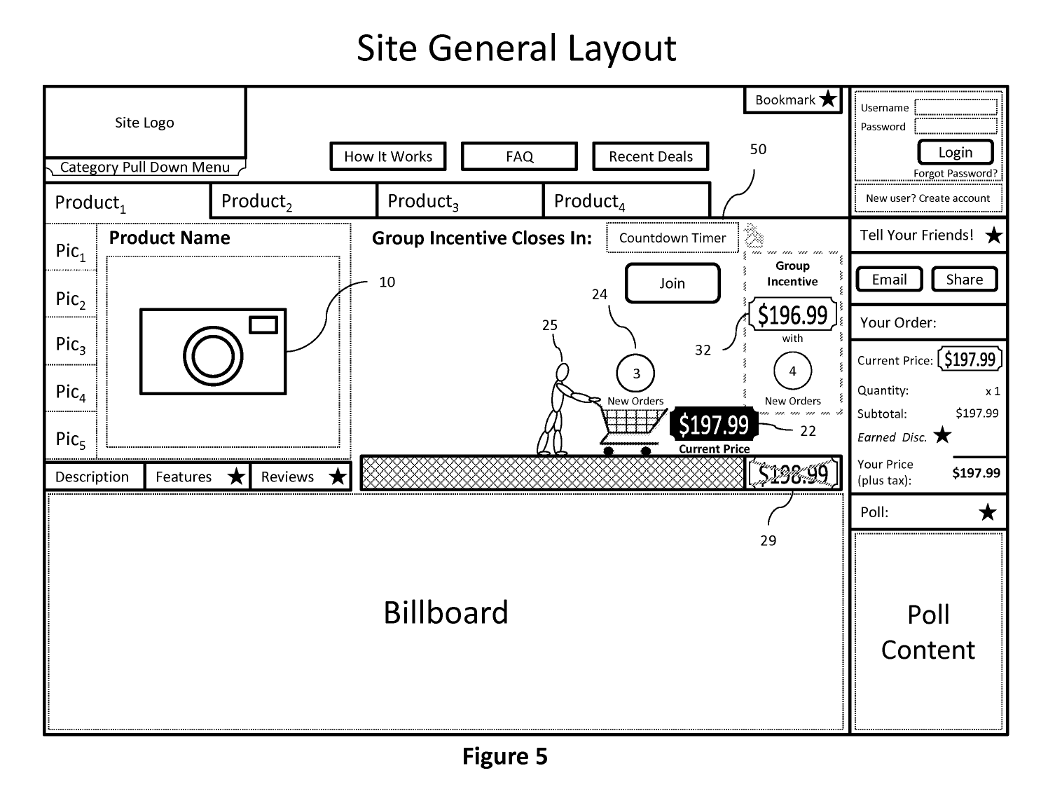

The web page is updated as shown in FIG. 3. The number of orders at the current price 24 is now one (1). This process is repeated as shown in FIGS. 4 and 5. Each time the product/service is ordered, the position of the price porter 25 moves towards the right along the platform 27. In this particular example, the price porter 25 moves from left to right. It should be understood that a wide variety of animations could be used and that animation movement can be in any form or direction in order to indicate progress towards a goal or to promote, encourage or influence the user to buy the product/service, in the event that the user has not committed to a purchase. The methodology of the animation management is discussed in more detail below.

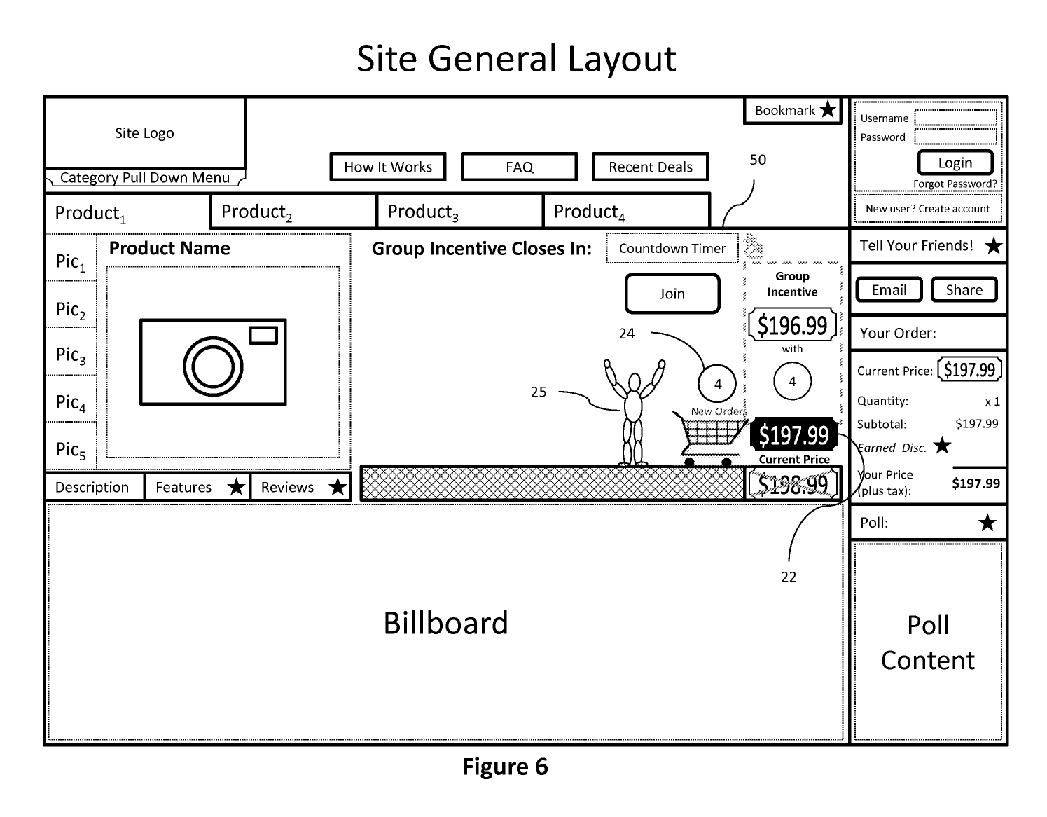

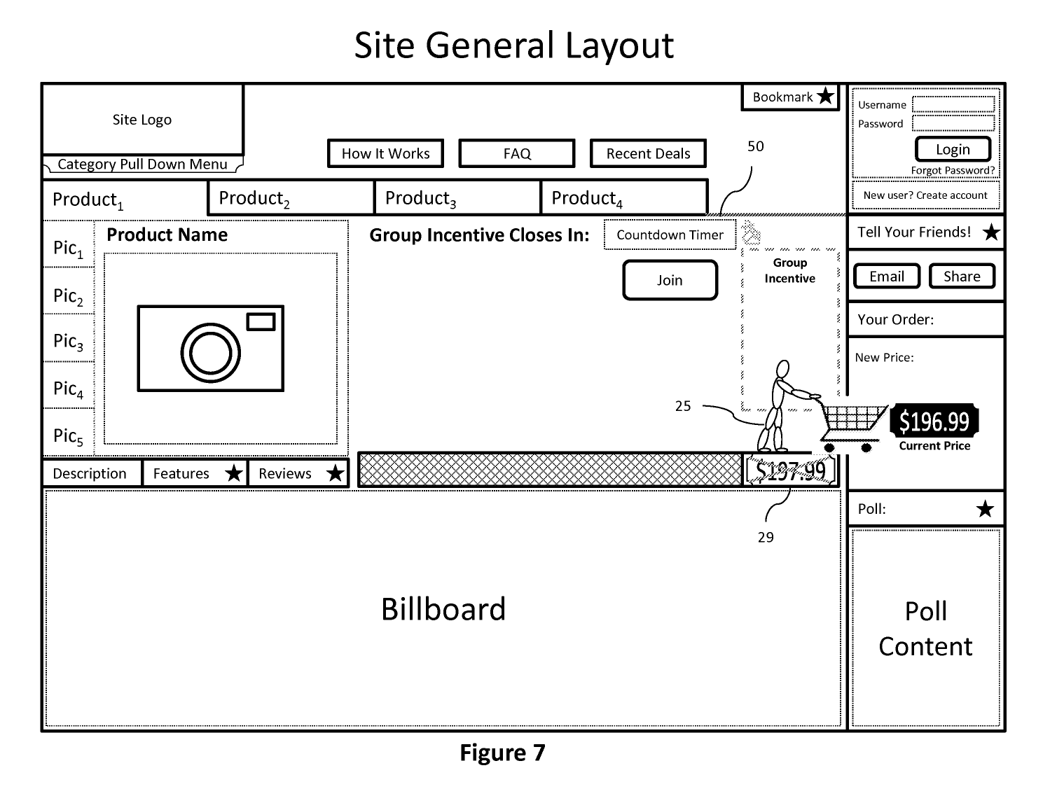

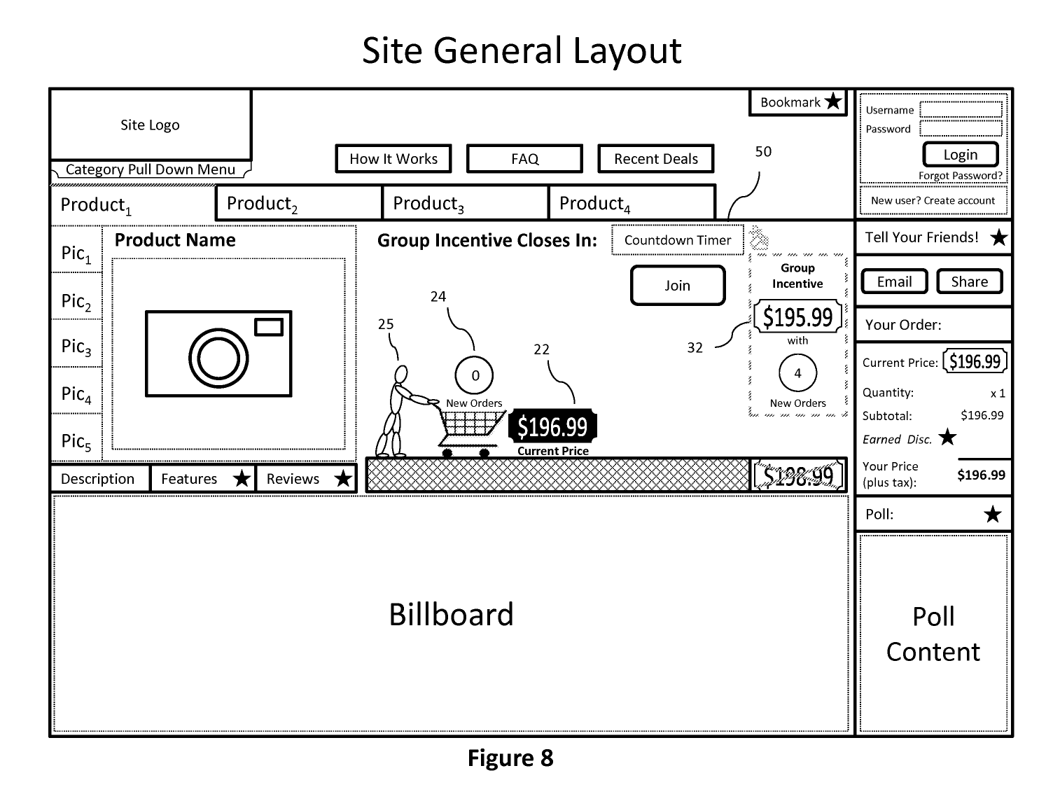

The number of orders at the current price 24 is incremented to reflect progress towards the target number of orders 34. Once the target number of orders 34 is reached, the price porter 25 reaches the pit 29 as shown in FIG. 5. The current price 22 drops into the pit 29 and the price porter picks up the new, lower price (target price 32) as shown in FIGS. 6 and 7. The system resets position of the price porter 25, the target price 32 and the number of orders at the current price 24 as shown in FIG. 8. It should be that a wide variety of animations could be used without departing from the scope of this disclosure.

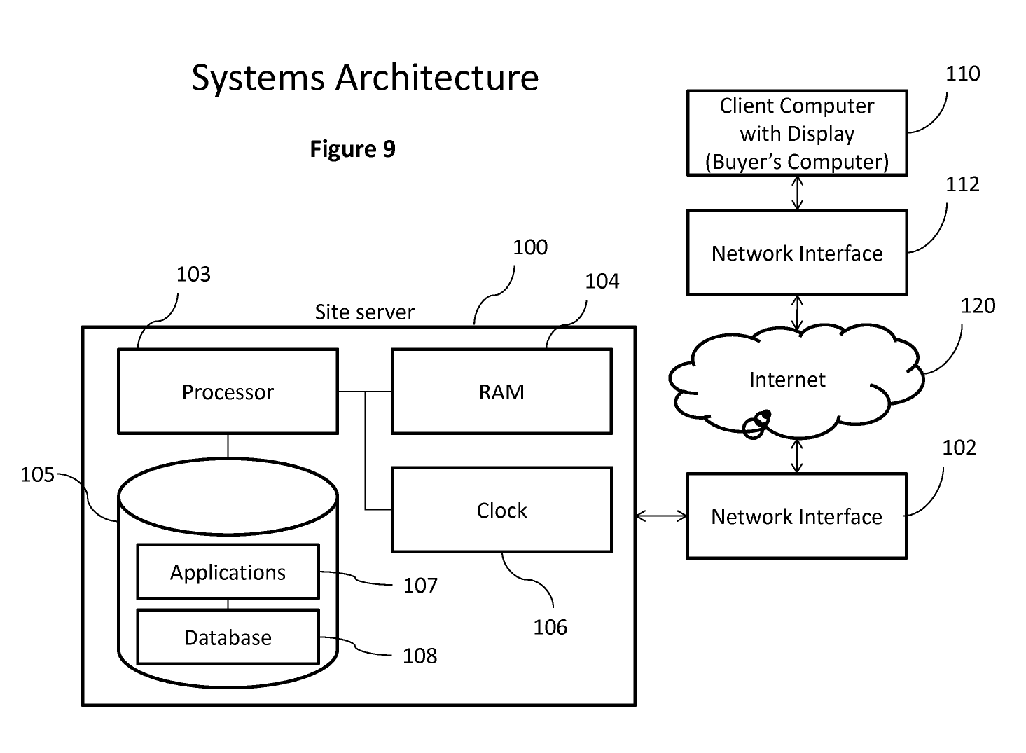

FIG. 9 is an example system architecture block diagram. The system can include a server 100 that is coupled to a client computer 110 via a network (e.g., Internet 120). The server 100 and client computer 110 can include network interfaces 102 and 112 respectively. It should be understood that network interfaces 102 and 112 can be wired or wireless. The site server 100 can be implemented using traditional components such as a processor 103 and various forms of memory 104, 105 (e.g., ROM, RAM, solid state memory, magnetic disk, optical disk and other non-transitory computer readable media). The server can also include various applications 107 and product/service information (e.g., stored in database 108). The server can also include at least one clock 106, that can be used to implement one or mote count down timers associate with one or more deals. It should be understood that each clock 106 can be implemented via hardware, software or a combination thereof. The client computer 110 can also be implemented using components such as a processor, various forms of memory, operating software and a browser application. It should be understood that the client computer 110 can encompass any computing platform including: desktop computers, laptop computers, tablet computers, PDA's, cell phones and the like.

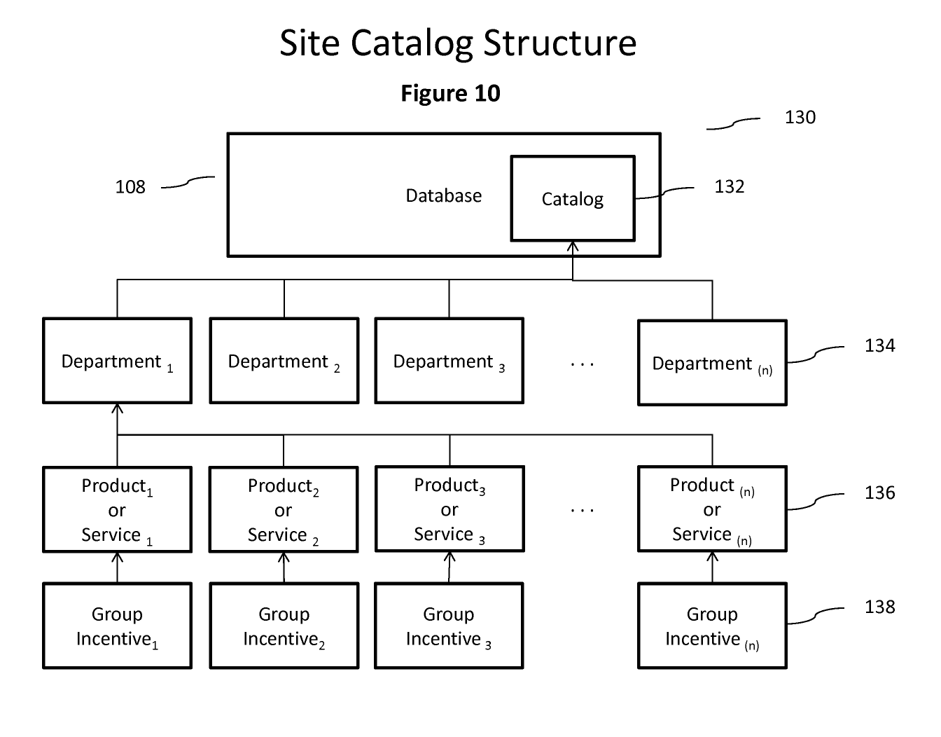

FIG. 10 shows an example catalog structure 130 block diagram. Product information can be stored in a catalog 132. It should be understood that database 108 can be implemented in any form including a relational database as well as simpler formats such as a flat file. The catalog can be broken down into multiple levels for example, one or more departments 134 having one or more products/services 136. Each product/service can be associated with group incentive information 138. The group incentive information 138 can generally include the information discussed above (e.g., target price 32 and the target number of orders 34).

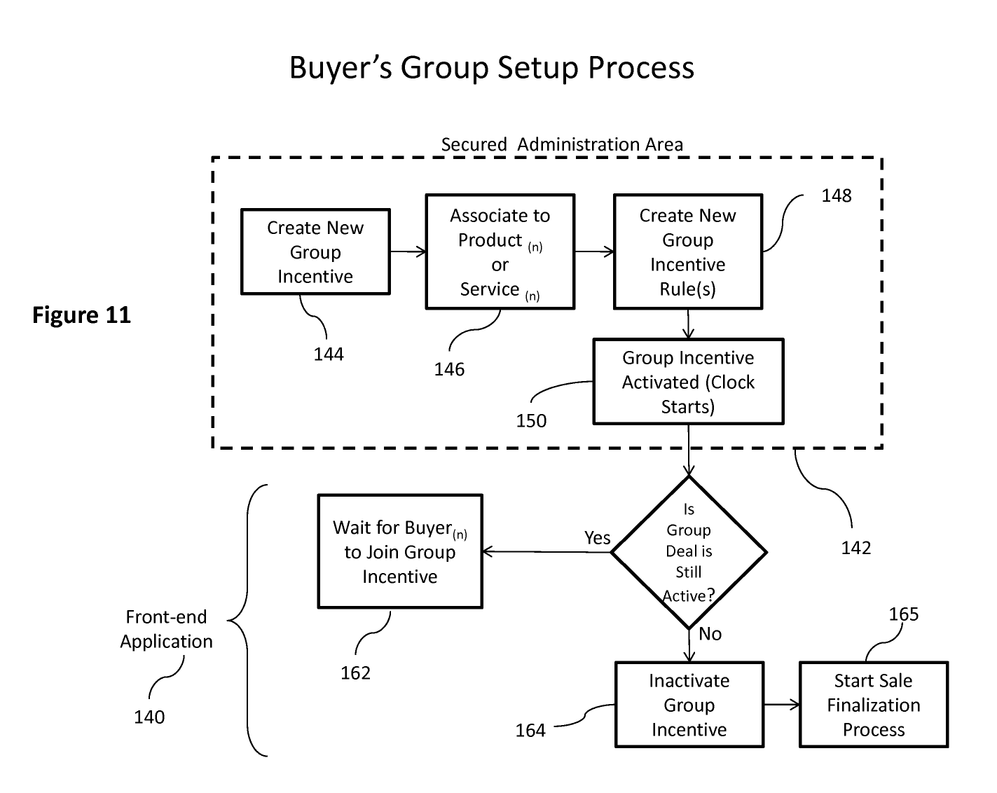

FIG. 11 is a block diagram of an example group incentive setup process. A frontend application 140 generally includes a secure area 142. The secure area 142 includes a routine for creating a new group incentive or deal 144. The new group incentive can be associated with one or more product or services as shown by block 146. The group incentive can include a plurality of rules (e.g., target price 32, target number of orders 34, duration . . . ) as shown by block 148. Once the newly created group incentive is complete, it can be activated as shown by block 150 and a clock or timer can be started. It should be understood that a group incentive can be managed and/or activated manually (e.g., via user input) or automatically (e.g., via a schedule and/or bulk updates).

Once a group incentive is activated, application software can monitor its operation. As long as the deal is active orders can be accepted as shown by block 162. After the clock or timer expires, the deal is inactivated and no further orders are accepted as shown by blocks 164-165.

It should be understood that any flowcharts contained herein are illustrative only and that other program entry and exit points, time out functions, error checking routines and the like (not shown) would normally be implemented in typical system software. It is also understood that system software may run continuously after being launched. Accordingly, any beginning and ending blocks are intended to indicate logical beginning and ending points of a portion of code that can be integrated into a main program and called as needed. The order of execution of any of the blocks may also be varied without departing from the scope of this disclosure. Implementation of these aspects is readily apparent and well within the grasp of those skilled in the art based on the disclosure herein.

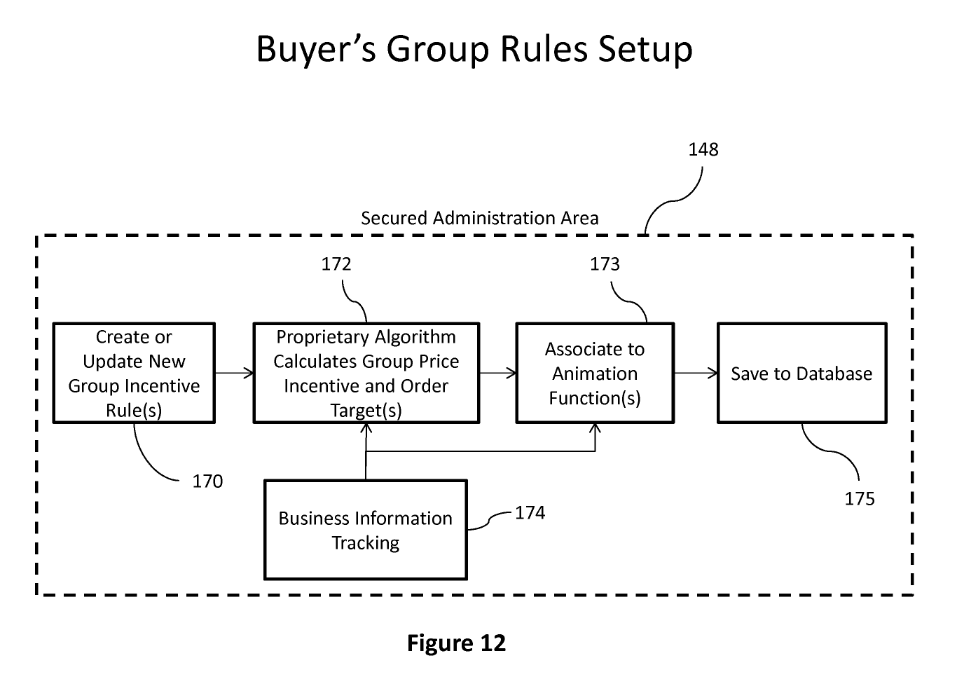

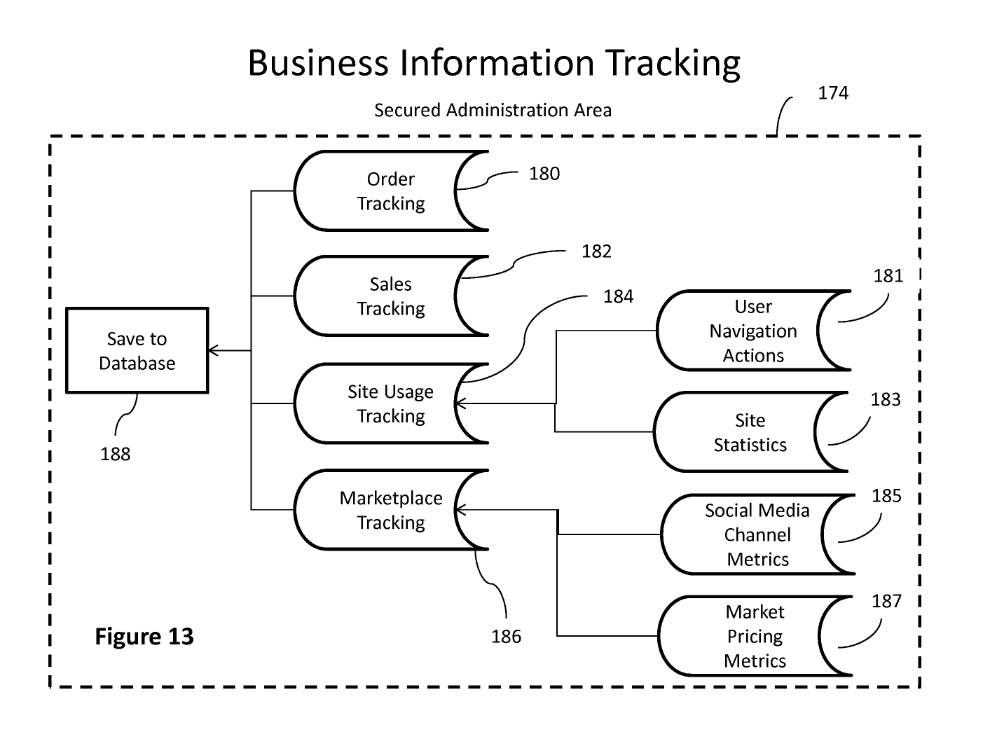

FIG. 12 is a block diagram of an example group incentive rules setup process 148. The process can include a routine configured to create or update new group incentive rules 170. The buyer group rules setup process can also include a routine that calculates a suitable target price and target number of orders as shown by block 172. Business information can be used as part of this calculation as shown by block 174. A programmatic function to trigger an animation event can be associated as shown by block 173. The newly created or updated group incentive rule can be stored in the database 105 as shown by block 175, e.g., database 108. FIG. 13 shows basic business information tracking including order tracking information 180, sales tracking information 182, site usage tracking information 184 and market place tracking information 186. Site usage information 184 may be composed of User Navigation Actions 181 intended to listen and monitor user events such as clicks or actions such as mouse movement coordinates collected using programmatic code; Site Statistics 183 intended to listen and monitor metrics such as number of unique visitors, number of visits, number of pages, number of hits (per visit), duration of visit, etc. collected with a 3rd party software solution. Market Place tracking information may include metrics that may convey consumer sentiment on products/services collected from social channels 185 such as Facebook, Twitter or Google +1 or the like and market pricing metrics 187 such a price comparison sites or from competitive product retailers themselves. Some of this information can be filtered accordingly and contextualized to fit the desired application of this invention and updated on a regular basis and stored in the user's computer 110 as data and/or in a database, e.g., database 108, as shown by block 188. The methodology for acquisition of this Business Information Tracking can be integrated onto the web site through 3^{rd} party applications. It is understood that not all these sub-systems need to be integrated to make this invention possible but its effectiveness and the intelligence of the results will be enhanced when all these sub-systems are integrated. The metrics may be calculated on the server side using various statistic, trend and forecasting modeling methods and derived into various algorithms which results will be associated to pre-determined programming functions that could define the next quantity or price target or trigger commands to activate or execute one or a plurality of animation or video events that will be eventually shown to the individual. The animations that may be used can be of standard web-friendly image file formats like jpeg, pic, gif, or a conglomeration of images stitched together in a given sequence like animated gif or rendered video file formats like mov, mpeg, avi, mwa, mwv, asf, swf 3g2, 3gp, swf, f4v, for example. Another alternative is to use html or html5 in combination with CSS (cascading style sheets) in order to get an animated rendering. Another alternative, if the marketing company sees fit to apply, the animation or video file formats can include audio embedded in the animated video or separately. These file formats should not be limited, as new and better file formats become available in the industry.

Any computer programming code such as Javascript, PHP, C+ for example, can be used to provide the logic for the specific algorithms and to create a set of functions in order to drive the functionality of the animation system. The programming code can be embedded in the html of the web pages or exist on the server side.

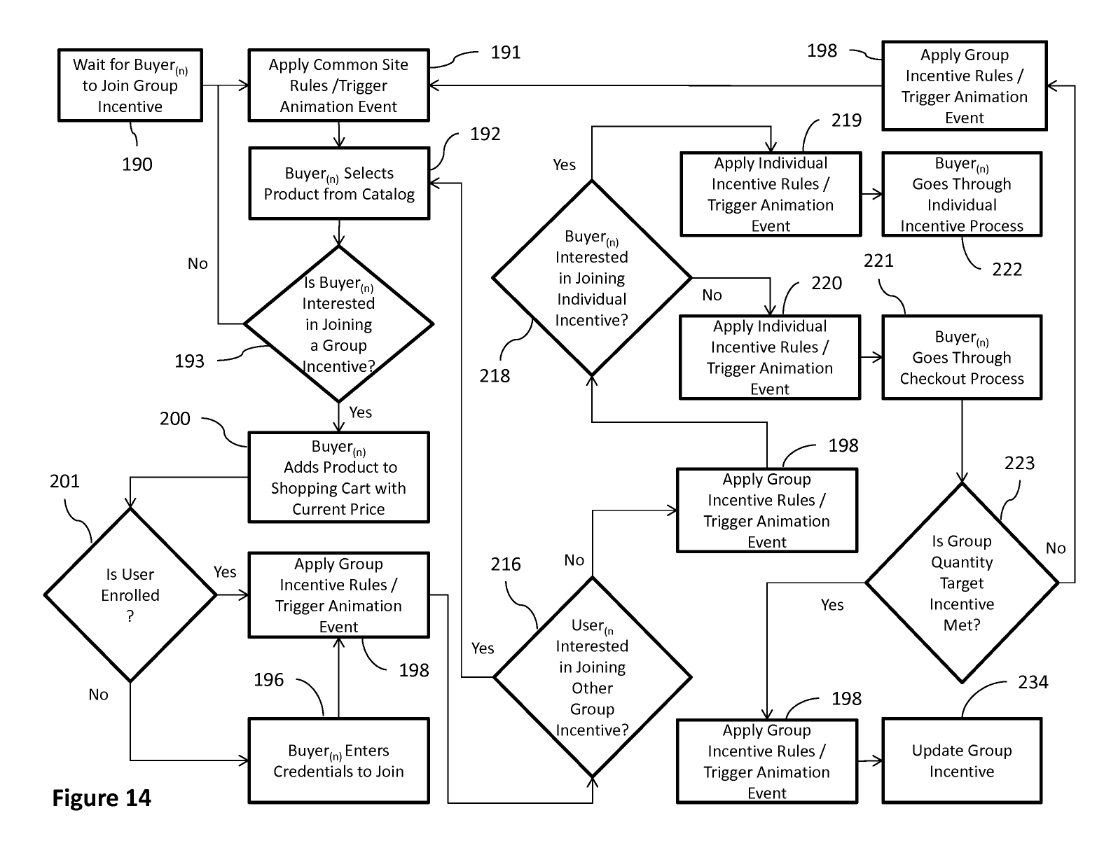

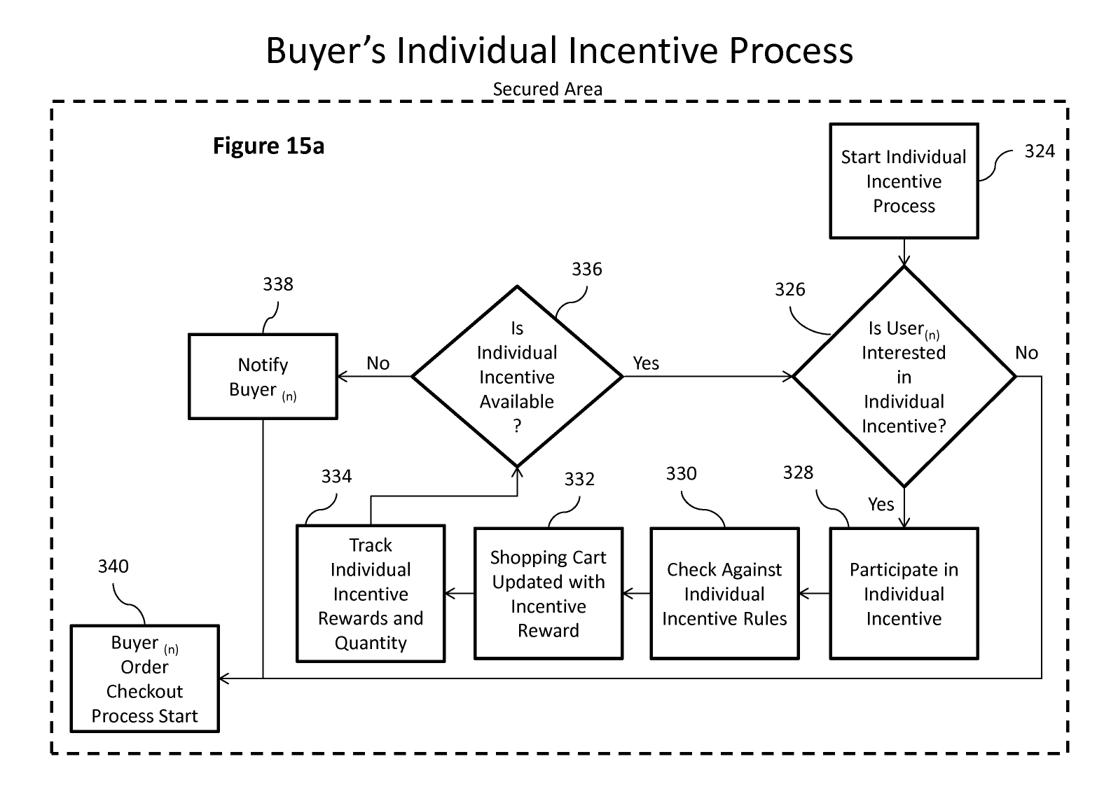

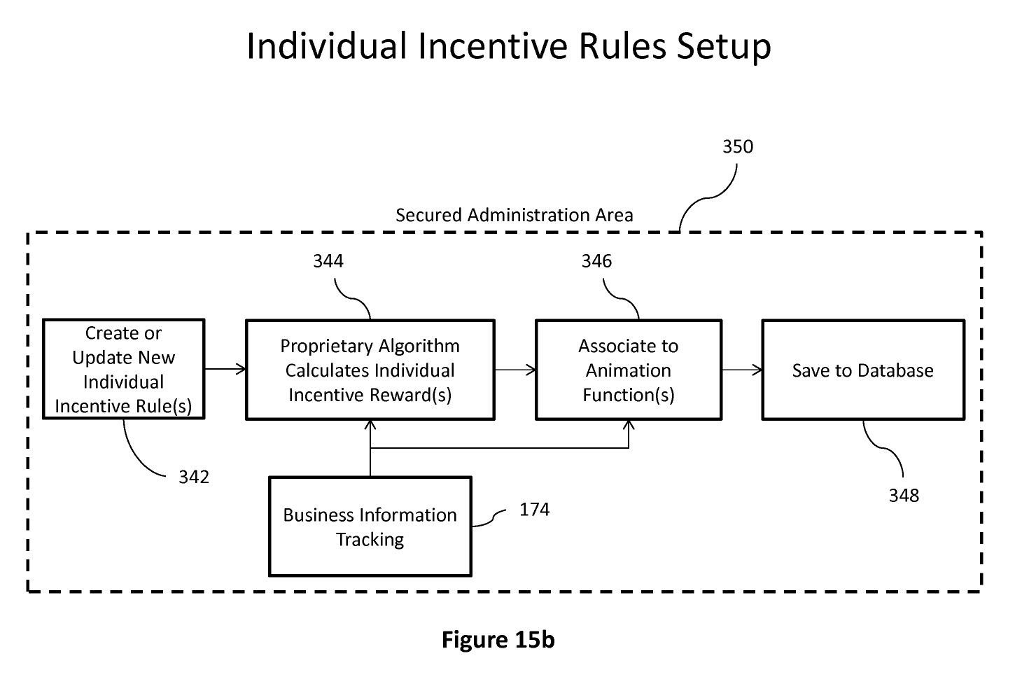

FIG. 14 is a flowchart showing the group and individual incentive processes working together. Once a group incentive is active, the system waits for a buyer to join (block 190). Common site-wide rules may be applied once the presence of a user is detected and can trigger an animation event (block 191). The buyer can select a product/service from the catalog 132 as shown by block 192. If the buyer is an enrolled member of the web site 201 and wishes to purchase the product/service (join the group incentive 193), they can click on the order button 40 (see also FIG. 1a and FIG. 2) to add product/service to their shopping cart 200. The buyer is prompted to enter various identifying information as shown by block 196. The system can then verify the order complies with the group incentive rules as shown by block 198. Assuming the order complies with the group incentive rules, the buyer's shopping cart is updated with the current price as shown by block 200 and the number of orders at the current price is updated as shown by block 210 using one or a plurality of animation events according to its associated group incentive rules 198. The sequence of an example animation triggered by block 198 to update the number of orders for the group deal, is illustrated by blocks 212 and 214 (See also FIGS. 6-8). If the target number of orders is met, the system can update to a new target price as shown by blocks 223, 198 and 234 (See also FIGS. 6-8 and FIG. 20). If the buyer is interested in joining another deal, the system can restart at block 192 via block 216. The system can additionally check and apply group incentive rules/trigger animation events as shown by block 198. This animation event can be used to re-motivate the buyer to reconsider not joining another group incentive 216. If a buyer is interested in joining an individual or user incentive, such orders can be handled as shown by blocks 218, with an option to check and apply individual incentive rules/trigger animation events as shown in block 219. The user can then complete the individual incentive process 222. Otherwise, if the buyer is not interested in joining an individual, then the system can additionally check and apply individual incentive rules/trigger animation event as shown by block 220 and complete the checkout process as shown by block 221. The system then checks if the group quantity has been met and checks and applies group incentive rules/trigger animation events. The database can be updated to track the various incentive awards as shown by block 234. FIG. 15a shows an example of processing an individual or user incentive 222. The process is started as shown by block 324. The buyer can elect to participate in an individual incentive as shown by block 328. The individual incentive is checked based on individual incentive rules as shown by block 330. The shopping cart is updated with an incentive reward as shown by block 332. Individual incentive rewards and quantity can be tracked as shown by block 334. The process can be repeated via block 326. If an individual incentive is not available the buyer is notified as shown by blocks 336 and 338. Once the process is complete, the checkout process can be initiated as shown by block 340. It is understood that business information tracking metrics 174 described in FIG. 12 and may also be applied to the individual incentive process.

FIG. 15b is a block diagram of an example individual incentive rules setup process 350. The process can include a routine configured to create or update new individual incentive rules 342. The individual rules setup process can also include a routine that calculates a suitable individual incentive reward as shown by block 344. Business information can be used as part of this calculation as shown by block 174. A programmatic function to trigger an animation event can be associated as shown by block 346. The newly created or updated individual incentive rule can be stored in the database, e.g., database 108, as shown by block 348.

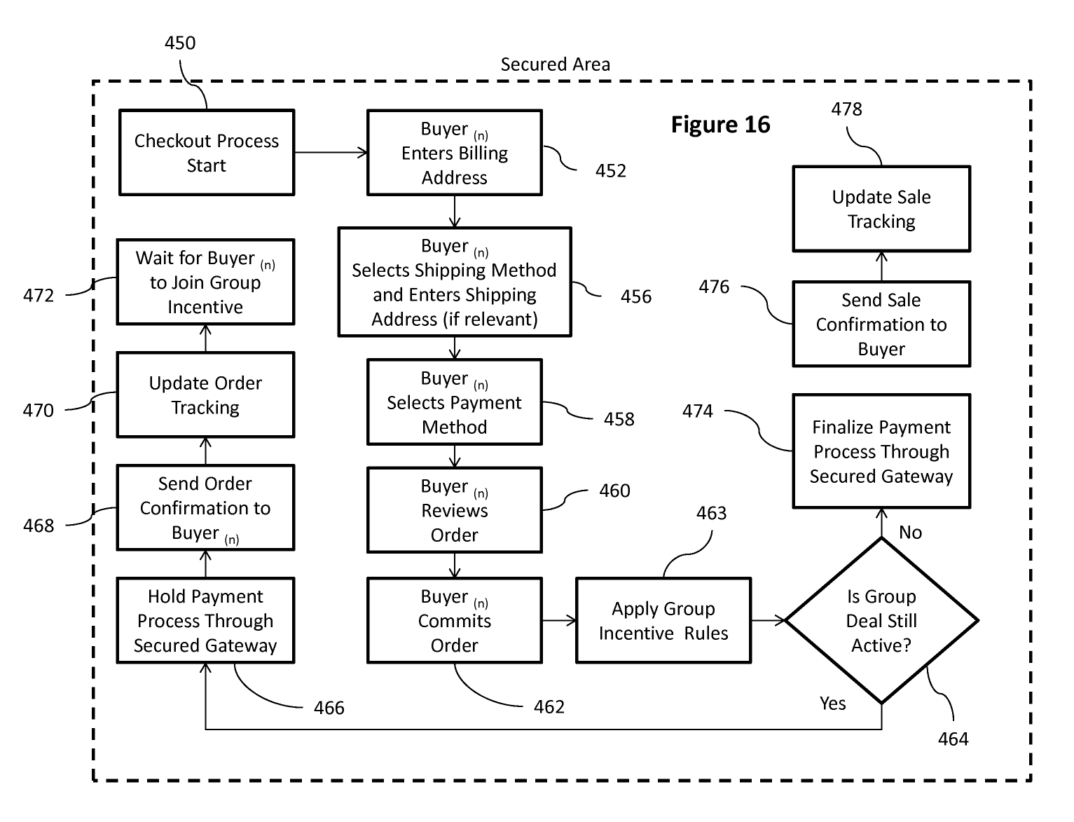

FIG. 16 is an example block diagram of the checkout process. The checkout process begins at block 450. The buyer enters various identifying information as show by blocks 452. The shipping method is selected as shown by block 456. A review screen can be provided as shown by block 460. The buyer can confirm the order selection as shown by block 462 and a group incentive rule can be applied as shown by block 463. Assuming the deal is still active, the process continues at block 466, if not processing continues at block 474. If the deal is still active, the final price is not yet set as discussed above. Final payment is held as shown by block 466. An order update and tracking information can be set to the user as shown by blocks 468 and 470. The system then waits for additional buyers to join the group incentive (or for the incentive to end) as shown by block 472. If the deal is no longer active, the final price is set to the current price at the time the deal closes. Payment can be finalized as shown by block 474. An order update and tracking information can be set to the user as shown by blocks 476 and 478.

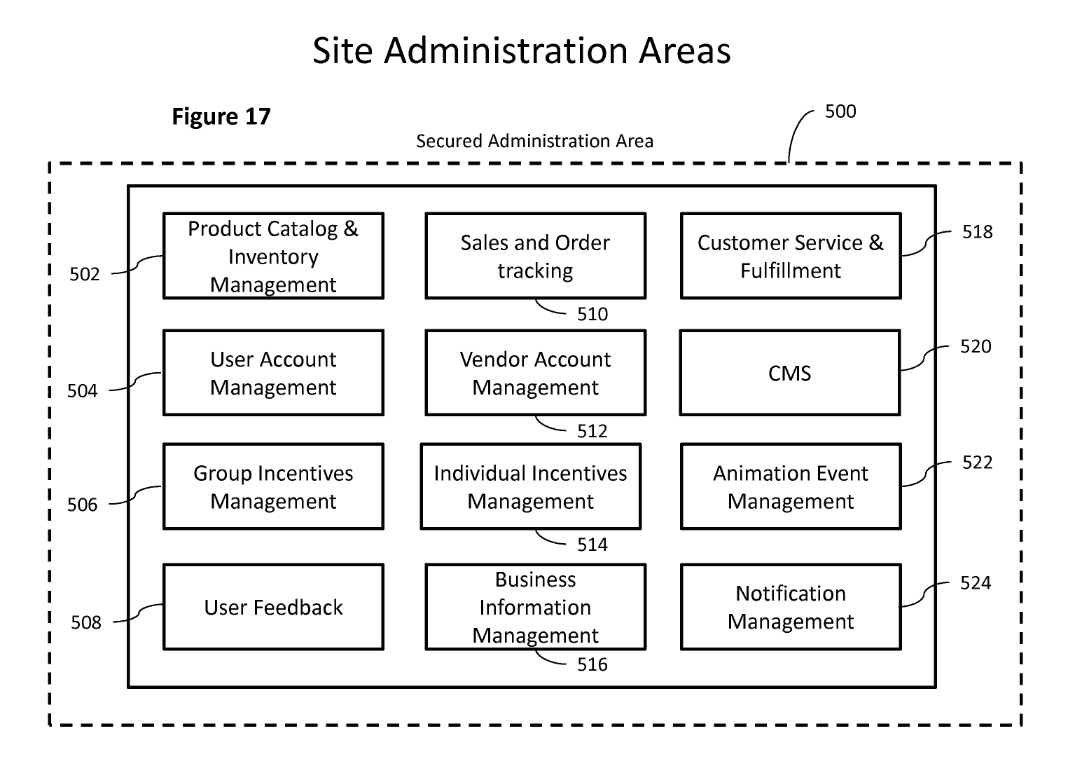

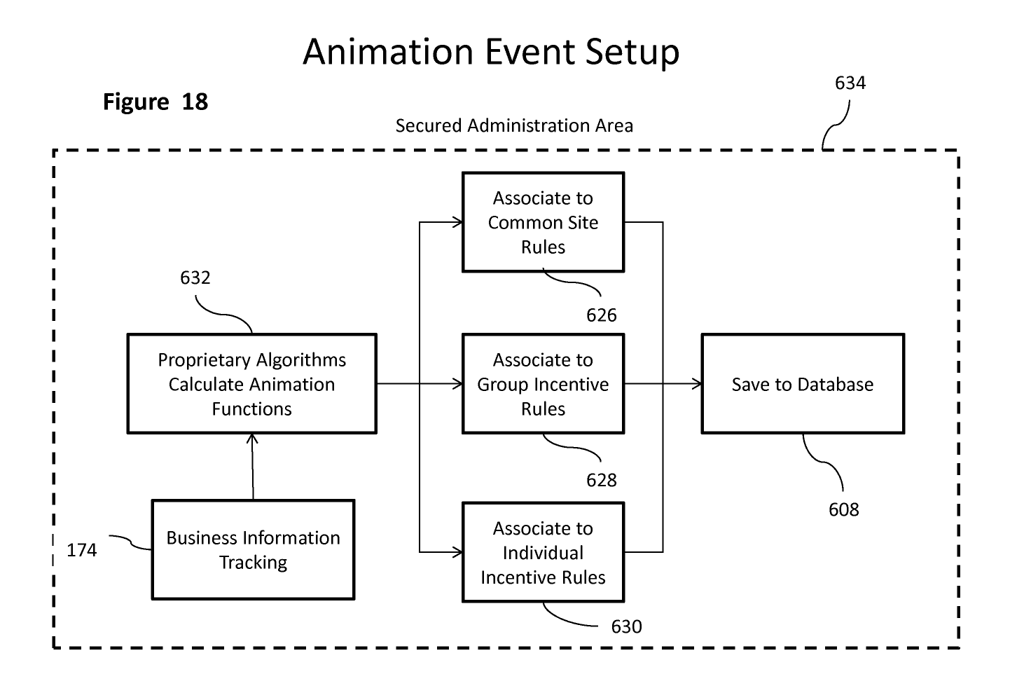

FIG. 17 is a block diagram showing various system administration functions 500. Such functions can include: product catalog and inventory management 502, user account management 504, group incentive management 506, user feedback 508, sales and order tracking 510, vendor account management 512, individual incentive management 514, business information management including site usage metrics 516, customer services and fulfillment 518, content management system (CMS) 520, animation event management 522 and notification management 524. Implementation of such functions is well within the scope of those skilled in the art based on the disclosure contained herein. FIG. 18, details further animation event setup process 634 where business tracking information 174 can be fed to provide in a conclusive manner through routine programmatic algorithms 632, to an administrator in order to configure, schedule, and associate a set of specific animation functions to a set of specific common site rules 626, group incentive rules 628, individual incentive rules 630, in order to meet a marketing or sales goal. These can be saved to a database as shown in block 608.

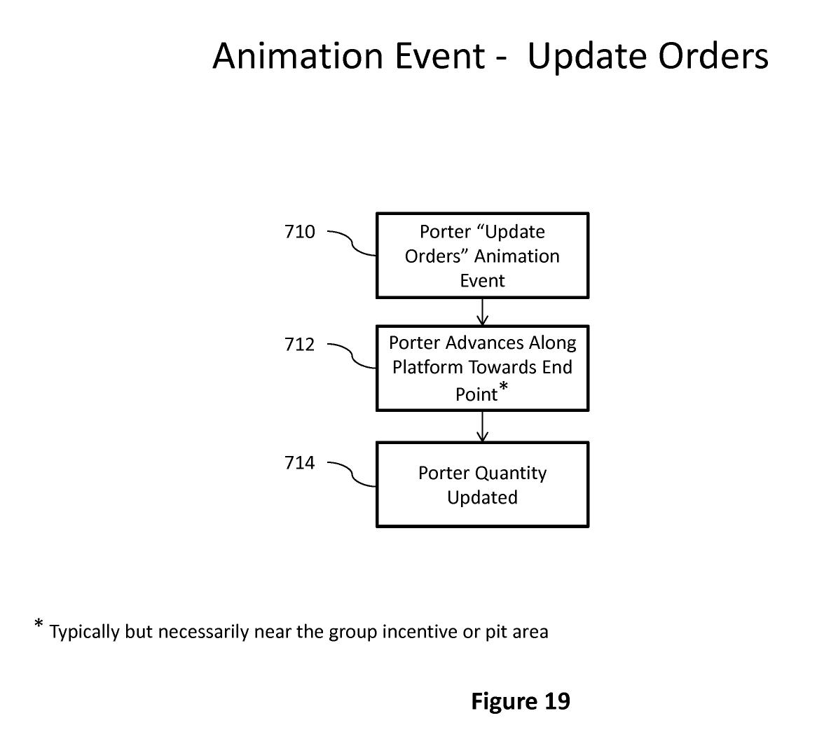

FIG. 19 is a block diagram showing an animation event associated with an order update. The porter “Update Orders” animation is executed as shown by block 710. The porter advances along the platform towards the end as shown by block 712. Typically the porter advances towards the pit as discussed above. The porter quantity 24 is updated as shown by block 714.

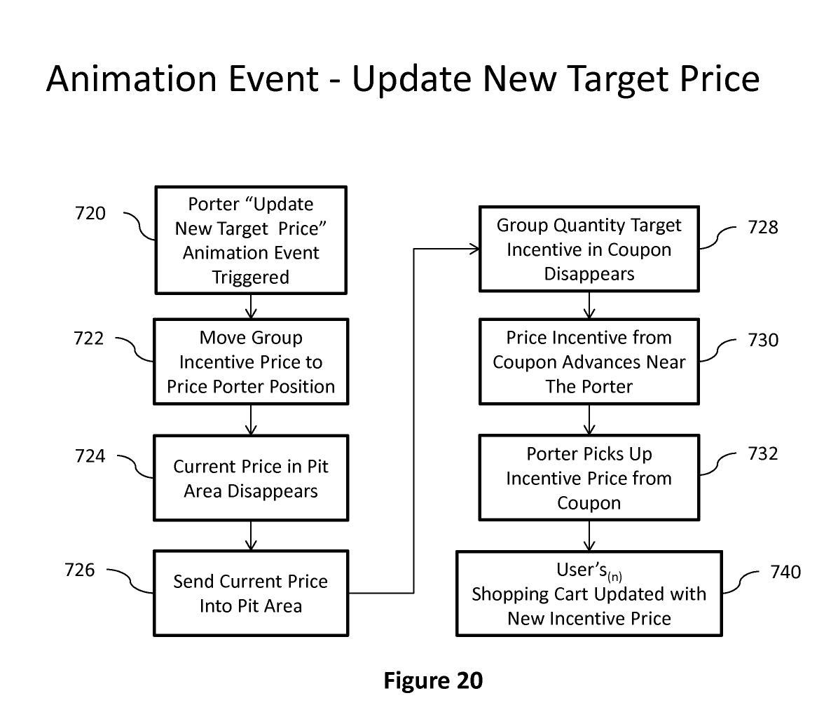

FIG. 20 is a block diagram showing an animation event associated with a new target price. The update new target price animation event is triggered as shown by block 720. The group incentive price is moved to the price porter position as shown by block 722. The current price in the pit area is removed (disappears) as shown by block 724. The current price is inserted into the pit are as shown by block 726. The group quantity target incentive in the coupon is removed (disappears) as shown by block 728. The price incentive from the coupon is advanced towards the porter as shown by block 730. The porter picks up the incentive price from the coupon as shown by block 732. The buyers' shopping cart is updated with the new incentive price as shown by block 740.

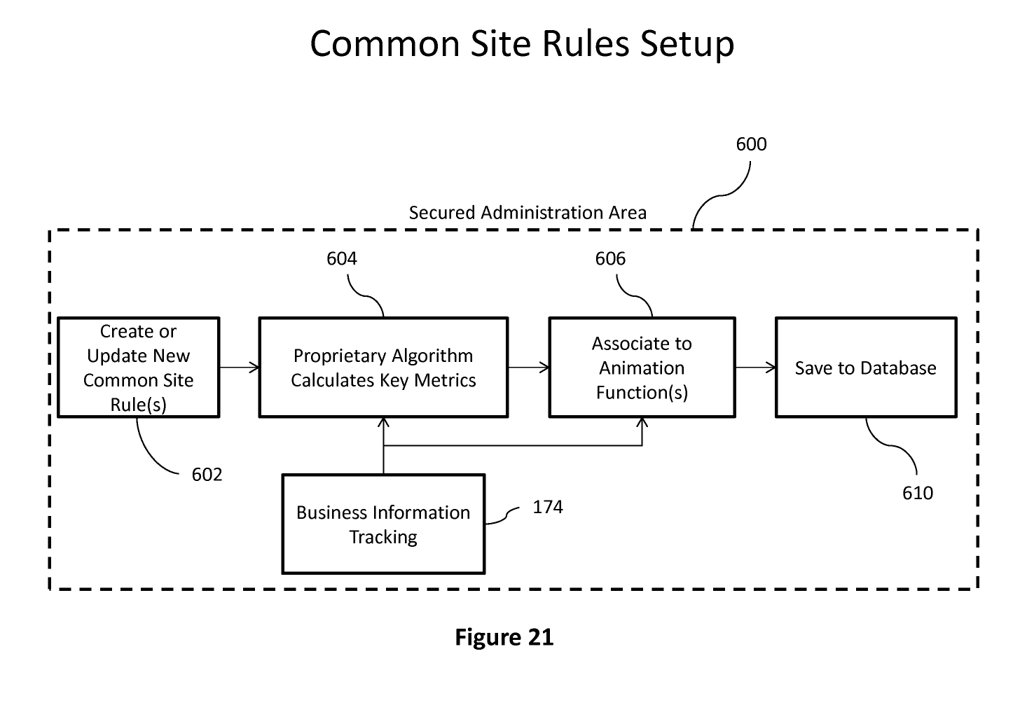

FIG. 21 is a block diagram of an example common site rules setup process 600. The process can include a routine configured to create or update new common site rules 602. The common site rules setup process can also include a routine that calculates key metrics as shown by block 604. Business information can be used as part of this calculation as shown by block 174. A programmatic function to trigger an animation event can be associated as shown by block 606. The newly created or updated common site rule can be stored in the database, e.g., database 108, as shown by block 610.

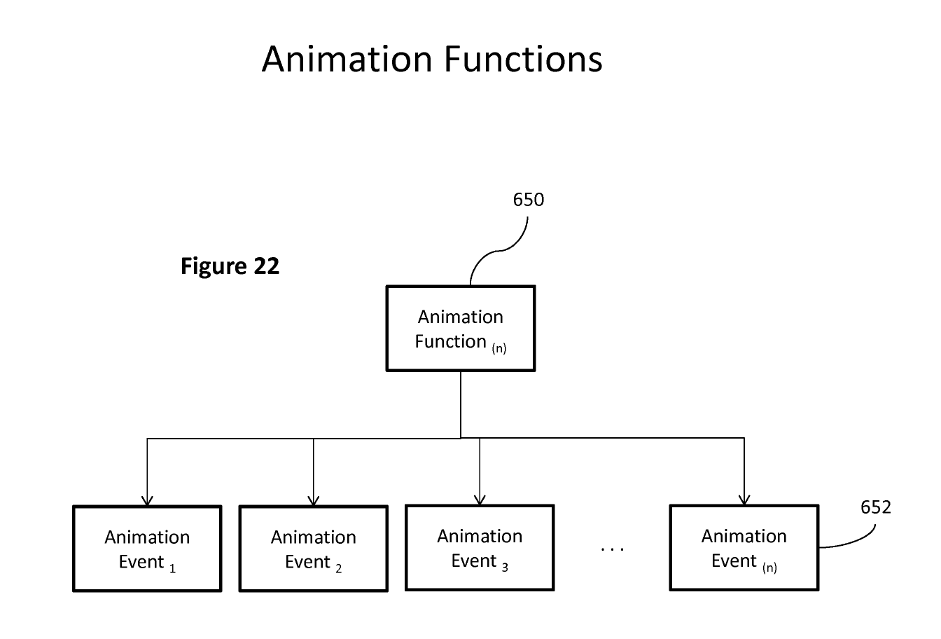

FIG. 22 is a block diagram that shows the relationship by association of one or a plurality of multiple events 652 to a given animation function 650.

Although features and elements are described above in particular combinations, each feature or element can be used alone without the other features and elements or in various combinations with or without other features and elements. The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

1. A method for collective purchasing of a product/service, the method comprising:
storing a current price, current number of orders, target price and a target number of orders associated with the product/service;
receiving an order to purchase the product/service and incrementing the current number of orders;
on a condition that the current number of orders equals or exceeds the target number of orders, updating the current price with the target price.

2. The method of claim 1, further comprising:
on a condition that the current number of orders equals or exceeds the target number of orders, updating the target price with a new target price.

3. The method of claim 1, further comprising:
providing current price indicia, current number of orders indicia, target price indicia and target number of orders indicia.

4. The method of claim 3, further comprising:
wherein at least one of the current price indicia, current number of orders indicia, target price indicia and a target number indicia are animated to reflect changes in the current price, current number of orders, target price or target number of orders.

5. The method of claim 4, further comprising:
providing an animation configured to indicate a relationship between the current number of orders and the target number of orders.

6. The method of claim 1, further comprising:
establishing a time period during which the product/service is available for sale;
storing a timer associated with the time period;
on a condition that the timer reaches a threshold, storing a final price based on the current number of orders.

7. The method of claim 6, further comprising:
on a condition that the timer reaches a threshold, preventing further purchase of the product/service at the final price.

8. The method of claim 6, further comprising:
on a condition that the timer reaches a threshold, finalizing the current price based on the current number of orders.

9. The method of claim 6, further comprising:
performing initial order processing when the order is placed based on the current price; and
finalizing the order based on the final price.

10. The method of claim 6, wherein the initial order processing includes an authorization hold.

11. A computer implemented system for collective purchasing of a product/service, the system comprising:
memory locations configured to store a current price, current number of orders, target price and a target number of orders associated with the product/service;
a user interface configured to receive an order to purchase the product/service and incrementing the current number of orders;
an application configured to update the current price with the target price on a condition that the current number of orders equals or exceeds the target number of orders.

12. The system of claim 11, wherein the application is configured to update the target price with a new reduced target price on a condition that the current number of orders equals or exceeds the target number of orders.

13. The system of claim 11, wherein the user interface is configured to provide current price indicia, current number of orders indicia, target price indicia and target number of orders indicia.

14. The system of claim 13, wherein at least one of the current price indicia, current number of orders indicia, target price indicia and a target number indicia are animated to reflect changes in the current price, current number of orders, target price or target number of orders.

15. The system of claim 14, wherein the user interface is configured to provide an animation configured to indicate a relationship between the current number of orders and the target number of orders.

16. The system of claim 11, wherein the application is configured to establish a time period during which the product/service is available for sale;
store a timer associated with the time period; and
on a condition that the timer reaches a threshold, store a final price based on the current number of orders.

17. The system of claim 16, wherein on a condition that the timer reaches a threshold, the application is configured to prevent further purchase of the product/service at the final price.

18. The system of claim 16 wherein on a condition that the timer reaches a threshold, the application is configured to finalize the current price based on the current number of orders.

19. The system of claim 16, wherein the application is configured perform initial order processing when the order is placed based on the current price and finalize the order based on the final price.

20. The system of claim 16, wherein the initial order processing includes an authorization hold.

21. The method of claim 1, further comprising:
providing an animation configured to respond to business information tracking metrics in a time-based manner, based on the current number of orders and the target number of orders.
